(19) United States
(12) Patent Application Publication
(10) Pub. No.: US 2022/0227630 A1
(43) Pub. Date: Jul. 21, 2022

(54) SIMULTANEOUS PROCESS FOR THE PRODUCTION OF CARBON BLACK AND CARBON NANOSTRUCTURES

(71) Applicants: BIRLA CARBON U.S.A., INC., MARIETTA, GA (US); BIRLA CARBON INDIA PRIVATE LIMITED, MUMBAI (IN)

(72) Inventors: ARATI VARMA, MUMBAI (IN); YOGESH LAXMAN BOROLE, THANE (EAST) (IN); AMOL VINAYAK NIPHADE, THANE (WEST) (IN); RANJAN GHOSAL, NAVI MUMBAI (IN)

(21) Appl. No.: 17/611,263

(22) PCT Filed: May 15, 2020
(86) PCT No.: PCT/US2020/033223

§ 371 Date: Nov. 15, 2021

(30) Foreign Application Priority Data
May 15, 2019 (IN) 201921019296

(51) Int. Cl. C01B 32/162; C09C 1/48; B01J 23/755; B01J 19/24; B01D 53/26; B01D 53/48; B01D 53/81

(52) U.S. Cl. CPC C01B 32/162; C09C 1/48; B01J 23/755; B01J 19/2415; B01D 53/261; B01D 53/265; B01D 2257/30; B01D 53/81; C01P 2004/03; C01P 2004/04; C01P 2006/80; B01D 2253/1124; B01D 53/48

(57) ABSTRACT

Simultaneous method for the production of carbon black and carbon nanostructures, where the gases produced from the carbon black manufacturing process are utilized as feedstock in an integrated process for the production of carbon nanostructures.

### BACKGROUND

### Technical Field

The present disclosure relates to methods for the simultaneous manufacture of carbon black and carbon nanostructures. The disclosure also provides the carbon black and carbon nanostructures produced by such methods, and methods for the use thereof.

### Technical Background

Carbon black is utilized as a reinforcing filler or a pigment in a variety of applications. The manufacture of carbon black is typically conducted using large scale continuous processes, which can produce thousands of tons of carbon black per year. These manufacturing processes combust hydrocarbon feedstocks and generate, in addition to carbon black, thermal energy and tailgas containing hydrogen and various carbon containing gases. Traditionally, this tailgas has been used for fuel value, for example, to heat dryers in the carbon black manufacturing process.

Carbon nanostructures, such as nanotubes, fullerenes, and graphenes, are traditionally manufactured in limited quantities. The gases typically used to manufacture these carbon nanostructures can be costly and can require significant infrastructure to prepare more than experimental quantities. The cost of manufacturing and handling these carbon nanostructures has, to date, made commercialization difficult. Thus, a need exists for improved manufacturing methods for carbon nanostructures. This need and other needs are satisfied by the methods and compositions of the present disclosure.

### SUMMARY

In accordance with the purpose(s) of the invention, as embodied and broadly described herein, this disclosure, in one aspect, relates to methods for the simultaneous manufacture of carbon black and carbon nanostructures.

In one aspect, the present disclosure provides a method for the simultaneous production of carbon black and carbon nanostructures, the method comprising: introducing a carbon black feedstock into a carbon black reactor to produce carbon black and unutilized carbon black feedstock, and contacting the unutilized carbon black feedstock with a catalyst at an elevated temperature in a carbon nanostructure reactor to produce carbon nanostructures.

In another aspect, the present disclosure provides continuous methods for the simultaneous production of carbon black and carbon nanostructures.

In another aspect, the present disclosure provides methods for the production of carbon black and carbon nanostructures, wherein the carbon nanostructures comprise single walled carbon nanotubes, multi-walled carbon nanotubes, carbon fibers, fibrils, hollow carbon threads, solid carbon threads, fullerenes, graphenes, or mixtures thereof.

In another aspect, the present disclosure provides a carbon nanostructure prepared according to the methods described herein.

In still another aspect, the present disclosure provides a method for the production of carbon nanostructures, the method comprising: contacting unutilized carbon black feedstock obtained from the production of carbon black with a catalyst at elevated temperature to produce carbon nanostructures.

### BRIEF DESCRIPTION OF THE DRAWINGS

The accompanying figures, which are incorporated in and constitute a part of this specification, illustrate several aspects and together with the description serve to explain the principles of the invention.

FIG. 1 is a schematic illustration of a conventional carbon black manufacturing process.

FIG. 2 is a simplified schematic of a simultaneous carbon black and carbon nanostructure manufacturing process, in accordance with various aspects of the present disclosure.

FIG. 3A is a scanning electron micrograph of carbon nanostructures produced using unutilized carbon black feedstock from the manufacture of an N-326 grade carbon black, in accordance with various aspects of the present disclosure.

FIG. 3B is a scanning electron micrograph of carbon nanostructures produced using unutilized carbon black feedstock from the manufacture of an N-220 grade carbon black, in accordance with various aspects of the present disclosure.

FIG. 4A is a transmission electron micrograph of carbon nanostructures produced using unutilized carbon black feedstock from the manufacture of an N-326 grade carbon black, in accordance with various aspects of the present disclosure.

FIG. 4B is a transmission electron micrograph of carbon nanostructures produced using unutilized carbon black feedstock from the manufacture of an N-220 grade carbon black, in accordance with various aspects of the present disclosure.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, example methods and materials are now described.

As used herein, unless specifically stated to the contrary, the singular forms “a,” “an” and “the” include plural referents unless the context clearly dictates otherwise. Thus, for example, reference to “a filler” or “a solvent” includes mixtures of two or more fillers, or solvents, respectively.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance can or can not occur, and that the description includes instances where said event or circumstance occurs and instances where it does not.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

Unless indicated otherwise, parts are parts by weight, temperature is in ° C. or is at ambient temperature, and pressure is at or near atmospheric.

As briefly described above, the present disclosure provides methods for the simultaneous, or near simultaneous manufacture of carbon black and carbon nanostructures.

### Carbon Black Manufacture

In one aspect, carbon black is a finely divided form of carbon produced by the incomplete combustion of heavy oil, such as FCC decant oil, coal tar, and/or ethylene cracking tar; these may commonly be referred to as carbon black feedstock. In a typical manufacturing process (“furnace process”), the feedstock cannot be fully converted to carbon black. The leftover, or unutilized feedstock manifests itself in the form of gaseous products which are typically recovered, and used for the generation of energy.

According to the present invention, through the introduction of optional additional processing steps, the unutilized carbon black feedstock is used to form various carbon nanostructures. The carbon nanostructures, which have varying levels of graphitic order, can take the form of nanofibers, nanotubes, nanosprings, amorphous carbon, other carbon materials, and combinations thereof.

In one aspect, the carbon black manufacturing portion of the present disclosure can comprise any conventional process for preparing carbon black. In another aspect, such process can comprise a furnace process. In other aspects, the carbon black manufacturing process can comprise all of, a portion of, and/or variations of the method and apparatus in one or more of U.S. Patent Publication Nos. 2004/0241081 and 2004/0071626, and U.S. Pat. Nos. 4,391,789, 4,755,371, 5,009854, and 5,069882, each of which are incorporated herein by reference in their entirety for the purpose of disclosing carbon black manufacturing methods and apparatus.

Various methods for production of carbon black are known in the art. Generally, the production of carbon black is performed in a reactor by partial combustion and/or pyrolytic conversion of hydrocarbons. In this conventional reactor process for manufacturing carbon black, a hydrocarbon fuel, commonly natural gas or fuel oil, is burned in a stream of process air furnished by a blower. The hot gases produced by the combustion of the fuel flow through a vessel, usually lined with refractory, and ordinarily of circular cross section. A feedstock oil, usually highly aromatic, which serves as the chief source of carbon in the system, is injected into the flowing hot gases downstream of a point where the combustion of the fuel is complete. The oil feedstock is typically vaporized as one step in the carbon black forming process. Vaporization is favored by high velocity of the hot gas stream, a high degree of turbulence, high temperature, and high degree of atomization of the oil.

The feedstock oil vapor is carried by the hot combustion gases, the combustion gases attaining temperatures of from about 2,400° F. to about 3,400° F., varying with the methods used for controlling combustion. Radiant heat from the refractory, heat directly transmitted by the hot gases, high shear and mixing in the hot gases, and combustion of a portion of the oil by residual oxygen in the combustion products all combine to transfer heat very rapidly to the feedstock oil vapors. Under these conditions, the oil feedstock molecules are cracked, polymerized and dehydrogenated, and progressively become larger and less hydrogenated until some reach a state such that they may be called nuclei of carbon. The nuclei grow in size, and at some stage there is coalescence of particles to form cluster-like aggregates. At the completion of the process, the hot gases containing the carbon black are quenched to a temperature low enough to stop or significantly slow the reactions, and to allow the carbon black to be collected by conventional means.

A broad variety of carbon blacks has been disclosed in the art. These carbon blacks differ in many properties from each other and are made by different processes. The main field of use of the blacks depends upon their properties. Since the carbon black, as such, cannot be sufficiently characterized by its chemical composition or by its ingredients, it has become widely accepted to characterize the carbon black by the properties it exhibits. Thus, the carbon black can, for example, be characterized by its surface area.

Carbon black is well known as a reinforcing agent for rubber to be used, for example, in compounds for the construction of tires. There are two general categories of carbon black used in the automotive tire industry. Certain types of carbon black are best used as reinforcing agents for tire tread compounds and other types of carbon black are best used for reinforcing agents in tire carcasses.

Tread type carbon blacks are usually produced by using a different process and reactor than that used for the production of carcass type carbon blacks. Tread blacks are small particle size. This requires a fast, hot reactor, i.e., higher velocity and temperature. Residence times for these processes are in the milliseconds order of magnitude. Tread blacks are made at higher velocities and lower ratios of oil to flowing gases than the carcass blacks.

Carcass type blacks comprise larger particles. In order for the particles to become large, the reaction is slow and done in a relatively low temperature reactor. Residence times are in the seconds order of magnitude. These carbon blacks are made at low velocities and high ratios of oil to flowing gases.

Typical carbon black reactors are disclosed in U.S. Pat. Nos. 4,822,588 and 4,824,643, which are also incorporated herein by reference in their entirety, wherein the reactors comprise a converging zone, a throat, a first reaction zone, and a second reaction zone serially connected. The reactor has a reaction flow passage having a longitudinal axis. The combustion zone and a reactor throat are positioned along the longitudinal axis of the reactor, and a converging zone converges from the combustion zone to the reactor throat. A quench zone is spaced apart from the reactor throat and has a cross sectional dimension generally larger than the cross sectional dimension of the reactor throat. A reaction zone connects the reactor throat with the quench zone. The reaction zone frequently has a cross sectional dimension less than that of the quench zone, and a length generally in the range of from 2 to 6 throat diameters. A burner is operably associated with the combustion zone to cause axial flow of hot combustion gases from the combustion zone to quench zone. At least one port for receiving an oil injector for introducing a carbonaceous feedstock radially inwardly toward the longitudinal axis of the reaction flow passage is provided in the reaction zone. The reactor is further provided with a means for introducing quench fluid into the quench zone. By providing oil injectors in the ports of both sides of the reactor throat, carbon black can be produced at high efficiencies.

Exemplary carbon black reactors, such as those described in the patents referenced above, comprise an upstream end, a converging zone, a reactor throat, a reaction zone, a quench zone, and a downstream end, and can be used to manufacture carbon black materials with a process comprising: (a) combusting a hydrocarbon fuel with excess amounts of oxygen-containing gas to form a mass of hot combustion gases containing free oxygen and flowing generally axially from the upstream end toward the downstream end of the reaction flow passage; (b) flowing the mass of hot combustion gases through the converging zone; (c) introducing a carbonaceous feedstock generally radially inwardly into the hot combustion gases at a position from the periphery of the converging zone to form a first reaction mixture; (d) flowing the first reaction mixture through the reactor throat, wherein the reactor throat has a radius and a diameter of two times the radius, past a first abrupt expansion in the reaction flow passage at a downstream end of the reactor throat, and into an upstream end of the reaction zone, said first abrupt expansion connecting the reactor throat with the reaction zone; (e) introducing additional carbonaceous feedstock generally radially inwardly into the reaction mixture at a position from the periphery of the reaction zone to form a second reaction mixture; and (f) flowing the second reaction mixture past a second abrupt expansion in the reaction flow passage at a downstream end of the reaction zone and into a quench zone having a sufficiently large diameter and length to provide for the formation of carbon black.

Such an exemplary reactor can have feedstock oil sprays located only downstream of the combustion zone of the reactor. The feedstock injectors are in the converging zone and in the reaction zone.

In another exemplary aspect, the carbon black reactor can comprise a combination combustion/reaction section that provides the desirable reaction volume for carcass carbon black types and combustion volume for tread carbon black types.

In a conventional carbon black manufacturing process, the smoke stream containing produced carbon black is filtered and densified to collect the carbon black. The resulting carbon black can further be formed into beads or pellets, and then optionally be subjected to a drying step. In such a process, the combustion gases can be recirculated into the reactor, cooled, or used for fuel value.

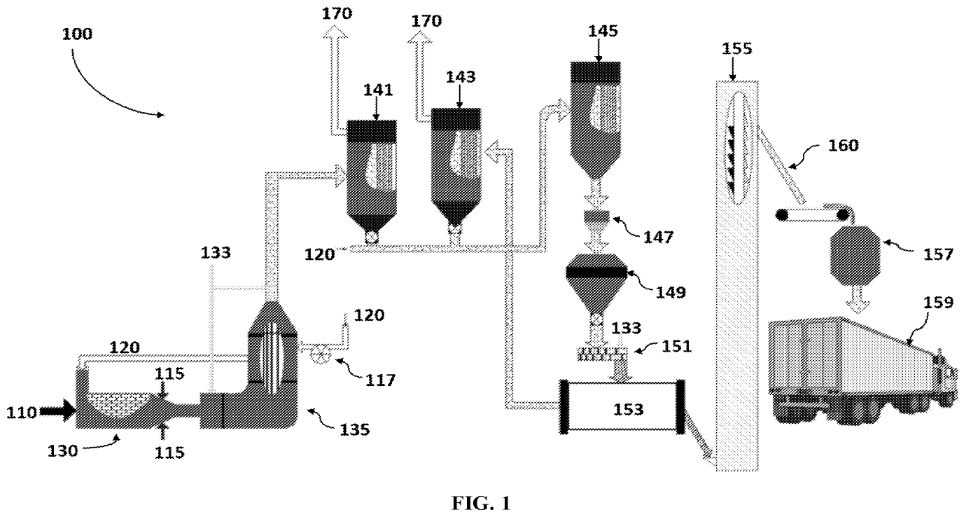

In one aspect, an exemplary carbon black manufacturing process 100 is illustrated in FIG. 1, wherein fuel oil and/or natural gas 110 and air 120 are introduced into a carbon black reactor furnace 130. All or a portion of the air can be introduced via a fan 117 and optionally passed through a heat exchanger 135 to raise the temperature of the air. Carbon black feedstock 115 can then be introduced where it is partially combusted to form carbon black particles. These particles can grow until the reaction is quenched via the introduction of water 135. The resulting smoke stream comprising carbon black, moisture, and unutilized carbon black feedstock can then be passed through the heat exchanger 135 and subjected to one or more initial processing steps, which can comprise separating the carbon black from the unutilized carbon black feedstock 170, sometimes referred to as tailgas. These initial processing steps can include the use of a main bag collector 141 and a secondary bag collector 145. The collected carbon black can then be passed through a pulverizer 147 to break up large agglomerates, and then to a densification tank 149 to increase the bulk density of the fluffy carbon black powder. In some cases, it can be desirable to package and transport carbon black in a beaded form instead of a powder form. In such cases, the carbon black can then be fed through a pin mixer 151, where water 135 and/or beading agents are introduced. The carbon black can then be fed through a dryer 153 to remove all or a portion of the moisture in the carbon black. Vapor from the dryer, which can contain carbon black, can also be recirculated to a vapor bag collector 143 for separation. In this exemplary aspect, the resulting carbon black 160 can be transported via, for example, an elevator 155 to a storage tank 157 and ultimately to a transportation means 159, such as a truck or railcar. It should be understood that the carbon black manufacturing process illustrated in FIG. 1 is intended to be exemplary in nature, and the current disclosure is not intended to be limited to this exemplary aspect.

One of skill in the art would be able to determine appropriate carbon black manufacturing methods and equipment, and the present disclosure is not intended to be limited to any particular carbon black manufacturing method or apparatus.

### Carbon Nanostructures

Carbon nanostructures are finding interest in several industrially significant applications. These nanostructures can comprise, without limitation, single walled carbon nanotubes, multiwalled carbon nanotubes, fibrils, carbon nanofibers, fullerenes, carbon threads, and graphenes. These carbon nanostructures, however, have found limited application because of the lack of cost-effective methods to manufacture them at high volumes. Various manufacturing methods exist for preparing carbon nanostructures, but such methods are typically inefficient, expensive, or suffer from low throughput or yield. Previous methods discuss the formation of carbon nanostructures via chemical vapour deposition, using various carbon sources such as acetylene, ethylene, CO and a suitable catalyst. The high cost of raw materials and synthesis processes for existing carbon nanostructure manufacturing methods result in the high cost of commercially available carbon nanostructures.

In conventional carbon black manufacturing methods, the carbon black feedstock is not completely converted into carbon black. A portion of this feedstock remains unutilized and can be present in the form of hydrogen and carbon containing gases. In this context, the unutilized carbon black feedstock present in the carbon black process contains constituents that could be effectively utilized for producing carbon nanostructures, provided the relevant processing steps are integrated into the carbon black manufacturing process. The present invention presents an innovative method for the simultaneous production of carbon black and carbon nanostructures.

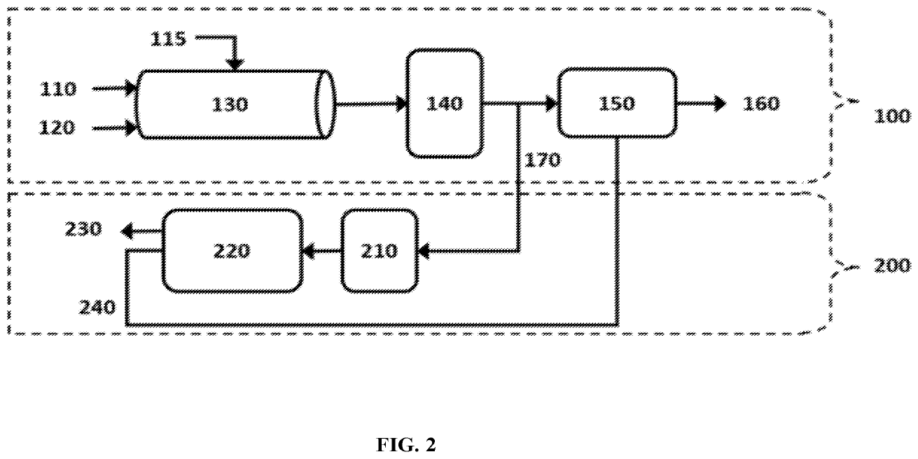

With reference to FIG. 2, an exemplary simultaneous process for producing carbon black and carbon nanostructures can comprise an integrated carbon black manufacturing process 100 and carbon nanostructure manufacturing process 200. In such an exemplary aspect, the combined system can comprise a carbon black furnace reactor 130, into which fuel oil and/or natural gas 110 and air 120 are injected. Carbon black feedstock 115 can then be injected to produce a smoke stream containing carbon black, moisture, and unutilized carbon black feedstock. This smoke stream can be directed to one or more initial processing steps 140, which can include bag collectors to separate carbon black from the unutilized carbon black feedstock, a pulverizer, and a densification tank. The collected carbon black can then be subjected to additional processing steps 150, such as, for example, a pin mixer to form carbon black beads, and a dryer 153. A portion of the unutilized carbon black feedstock 170, in gaseous form, can be removed from the carbon black manufacturing process and directed to the carbon nanostructure manufacturing process 200. The unutilized carbon black feedstock can be removed with a vent, slip-stream, or other configuration that allows the unutilized carbon black feedstock to be directed to the carbon nanostructure process. This unutilized carbon black feedstock can optionally be subjected to one or more treatment steps 210 to, for example, remove moisture, sulfur, or other impurities. In another aspect, the unutilized carbon black feedstock can be supplemented via the addition of one or more other components that can enhance the formation of desirable carbon nanostructures. The unutilized carbon black feedstock can then be directed to a carbon nanostructure reactor 220 to produce carbon nanostructures 230. In various aspects, the carbon nanostructure reactor can comprise a tube furnace, fluidized bed, or any other suitable reactor to produce desirable carbon nanostructures. In one aspect, the carbon nanostructure reactor can be operated in a batch mode wherein a portion of catalyst material is disposed in the reactor, for example, in an aluminum boat, and the unutilized carbon black feedstock is passed through the reactor. In another aspect, the carbon nanostructure reactor can be operated in a continuous or semi-continuous reactor wherein a portion of catalyst can be charged into the reactor in aliquots or in a continuous manner, and wherein the produced carbon nanostructures can be removed in aliquots or in a continuous manner. In another optional aspect, the unused or waste gas 240 flowing from the carbon nanostructure reactor can be redirected back to the carbon black manufacturing process 100, for example, into the carbon black dryer.

In the present invention, through the addition of a few innovative processing steps, the furnace black process can produce carbon nanostructures together with carbon black, without the addition of a separate carbon source. The process can thus produce carbon nanostructures in bulk, more effectively use portions of the carbon black feedstock that remain unused in the carbon black manufacturing process, and at potentially lower cost than existing methods.

In various aspects, carbon nanostructures can be produced in a batch process, a continuous process, or a semi-continuous process using unutilized carbon black feedstock The process is not limited to reactor type. In an exemplary aspect, a chemical vapour deposition (CVD) reactor comprising a tube furnace can be used, wherein a tube is substantially surrounded by one or more heating elements and provided with gas inlet outlet ports. In various aspects, the tube can comprise any material suitable for use with the methods described herein. In various aspect, the tube can comprise quartz, metal, or other materials, provided that such materials can withstand the temperatures utilized in the manufacturing methods and do not react with the unutilized carbon black feedstock or the produced carbon nanostructures. In one non-limiting aspect, a quartz tube, positioned such that its longitudinal axis is at a slight angle to horizontal and wherein the first end is elevated relative to the opposing second end, can be used. In this exemplary aspect, the quartz tube can comprise a first end comprising a gas inlet and charging port, and an opposing second end that is attached to a motor or means for rotating the quartz tube. In such an exemplary aspect, rotation of the tube can facilitate the flow of any carbon nanostructures produced therein. The opposing second end of the quartz tube can comprise a discharge port, which can be connected to a storage vessel or conveying system wherein produced carbon nanostructures are transported to a storage or subsequent processing system. In another aspect, the gas inlet, catalyst charging port, discharge port, collection vessel, and motor for rotation can comprise seals to prevent the escape of manufactured carbon nanostructures or the intrusion of oxygen or other gases. It should be understood that the exemplary aspects described herein are intended only to illustrate optional ways in which the methods of the present disclosure can be carried out. Other configurations, geometries, reactors, and equipment can be utilized, and one of ordinary skill in the art could readily select appropriate methods, equipment, and parameters for use in the combined methods of the present disclosure.

The formation of carbon nanostructures typically involves the use of a catalyst material to catalyze the decomposition of carbon containing gases. In various aspects, the chemical composition, size, and morphology of a catalyst material can often influence the type and properties of carbon nanostructure produced. The methods of the present disclosure are not limited to any particular catalyst, and one of ordinary skill in the art could readily select an appropriate catalyst material for use with the methods of the present disclosure. In one exemplary aspect, the catalyst can comprise an iron-nickel catalyst, an iron-cobalt magnesium oxide catalyst, or other catalyst known in the art. In one aspect, the catalyst comprises an iron-nickel catalyst. In an exemplary aspect, such an iron-nickel catalyst can have one or more of a BET surface area of from about 0.5×10¹ m²/g to about 5×10² m²/g, or about 5.36×10¹ m²/g, an elemental composition as determined by inductively coupled plasma (ICP) spectroscopy of from about 40% to about 60% iron and from about 15% to about 50% nickel, or about 49% iron and about 26% nickel. In yet another exemplary aspect, an iron-nickel catalyst material can have a mean particle sizes of from about 5 μm to about 10 μm, or about 8.7 μm. In other aspects, such a catalyst can have a particle size distribution having a D₉₀ of about 23.955 μm, a D₅₀ of about 8.765 μm, and a D₁₀ of about 2.233 μm. In still other aspects, a catalyst material can have a different size or distribution, and one of ordinary skill in the art could readily select an appropriate catalyst for the manufacture of carbon nanostructures. In one aspect, the catalyst of the present disclosure can be unsupported. In another aspect, the catalyst of the present disclosure can be supported, for example, on an alumina, silica, or other support. As briefly mentioned above, the catalyst material can be introduced to the carbon nanostructure reactor in batch fashion, for example, in a boat or reaction vessel, or in a continuous fashion, for example, via a catalyst charging port. Similarly, after formation of carbon nanostructures, the catalyst material, sometimes containing produced carbon nanostructures attached thereto, can be removed from the carbon nanostructure reactor in a batch fashion, for example, in a boat or reaction vessel, or in a continuous fashion, for example, via a discharge port. In one aspect, the ports, connections, and ends of the carbon nanostructure reactor can be sealed or designed to minimize or prevent leakage of produced carbon nanostructures and/or intrusion of oxygen or other gases.

The unutilized carbon black feedstock can comprise a mixture of gases, moisture, and sulfur. In various aspects, the unutilized carbon black feedstock can comprise hydrogen, nitrogen, one or more carbon containing gases, moisture, and optionally sulfur. It should be understood that the specific composition of unutilized carbon feedstock can vary depending on the feedstock source, carbon black furnace conditions, and the type of carbon black being produced, and the present invention is not intended to be limited to any particular gas or unutilized carbon black feedstock composition. In one aspect, the unutilized carbon black feedstock can comprise, on a dry basis, from about 0 vol. % to about 1.5 vol. %, from about 0 vol. % to about 1.2 vol. %, from about o vol. % to about 1 vol. %, from about 0 vol. % to about 0.9 vol. %, from about 0 vol. % to about 0.7 vol. %, from about 0.35 vol. % to about 0.7 vol. %, or from about 0.4 vol. % to about 0.65 vol. % methane; from about 0 vol. % to about 0.3 vol. % ethane; from about 0 vol. % to about 0.4 vol. %, from about 0 vol. % to about 0.3 vol. %, from about 0 vol. % to about 0.28 vol. %, or from about 0.2 vol. % to about 0.3 vol. % ethylene; from about 0 vol. % to about 75 vol. %, from about 20 vol. % to about 70 vol. %, from about 10 vol. % to about 65 vol. %, from about 25 vol. % to about 70 vol. %, from about 40 vol. % to about 70 vol. %, from about 50 vol. % to about 65 vol. %, from about 30 vol. % to about 72 vol. %, from about 10 vol. % to about 60 vol. %, from about 15 vol. % to about 70 vol. %, from about 20 vol. % to about 65 vol. %, or from about 48 vol. % to about 68 vol. % nitrogen; from about 0 vol. % to about 30 vol. %, from about 5 vol. % to about 30 vol. %, from about 10 vol. % to about 20 vol. %, or from about 12 vol. % to about 18 vol. % hydrogen; and from about 0 vol. % to about 30 vol. %, from about 5 vol. % to about 30 vol. %, from about 10 vol. % to about 20 vol. %, from about 12 vol. % to about 18 vol. %, or from about 15 vol. % to about 19 vol. % of carbon monoxide. Other gases or components may also be present in an unutilized carbon black feedstock. It should be understood that any one or more gases can be present or missing in a given unutilized carbon black feedstock and that the concentration of any one or more gases can be greater or less than any range or particular value recited herein, and the present invention is not intended to be limited to any particular unutilized carbon black feedstock composition.

In other aspects, the unutilized carbon black feedstock can comprise hydrogen and carbon monoxide in a ratio of from about 0.5:1 to about 15:1, from about 1:1 to about 12:1, from about 2:1 to about 15:1, from about 4:1 to about 15:1, from about 5:1 to about 15:1, from about 10:1 to about 15:1, from about 0.5:1 to about 10:1, from about 0.5:1 to about 8:1, from about 0.5:1 to about 6:1, from about 0.5:1 to about 4:1, from about 0.5:1 to about 2:1, or from about 0.5:1 to about 1:1. In other aspects, the ratio of hydrogen to carbon monoxide can vary and can be less than or greater than any ratio recited herein.

The unutilized carbon black feedstock can also comprise moisture. In various aspects, the moisture level of an unutilized carbon black feedstock, as it exists after the manufacture of carbon black, can be from about 10 wt. % to about 50 wt. %, from about 20 wt. % to about 40 wt. %, or about 30 wt. %. In some aspects, all or a portion of this moisture can be removed prior to using the unutilized carbon black feedstock to produce carbon nanostructures. Removal methods can comprise any methods suitable for with the present disclosure and selected by one of ordinary skill in the art, including condensers, cold traps, molecular sieves, dessicants, silica, or other adsorbents. In one exemplary aspect, moisture can be removed using a combination of one or more condensers, for example, in a parallel configuration, using tap water, by passing gas through a chiller maintained at a temperature of from about −3° C. to about −5° C., with a silica trap, or a combination thereof. In such aspects, the moisture content of the unutilized carbon black feedstock after removal can be from about 0 ppm to about 5,000 ppm, or from about 1,000 ppm to about 4,000 ppm. In other aspects, the unutilized carbon black feedstock can have a moisture level of less than about 5,000 ppm, less than about 4,000 ppm, less than about 3,000 ppm, less than about 2,500 ppm, less than about 2,000 ppm, less than about 1,000 ppm, or less than about 500 ppm. While not wishing to be bound by theory, removal of greater quantities of moisture can more readily facilitate the production of carbon nanostructures, but there can be practical limits to the removal of moisture from a gas stream in a continuous process.

Depending on the source of the carbon black feedstock, the sulfur content in the carbon black feedstock can vary. A portion of this sulfur may become incorporated into the carbon black, whereas a separate portion of this sulfur may become part of the unutilized carbon black feedstock. In one aspect, all or a portion of the sulfur can be removed from the unutilized carbon black feedstock, as some catalyst materials can be sensitive to the presence of sulfur. In one aspect, a trap, such as, for example, a cadmium hydroxide trap, can be used to remove all or a portion of sulfur from an unutilized carbon black feedstock. In some aspects, the sulfur level remaining in the unutilized carbon black feedstock for use in manufacturing carbon nanostructures can be less than about 500 ppm, less than about 400 ppm, less than about 300 ppm, less than about 250 ppm, less than about 200 ppm, less than about 150 ppm, less than about 100 ppm, or less than about 50 ppm.

In one aspect, the methods described herein can produce carbon nanostructures that grow on or in proximity to catalyst material within, for example, the quartz tube. In another aspect, carbon nanostructures can grow on the walls of the quartz tube or reaction vessel. The carbon nanostructures produced by the methods disclosed herein can be the same as or similar to those produced by other conventional methods, or they can comprise different morphologies and properties. In one aspect, the carbon nanostructures can comprise single walled carbon nanotubes, multi-walled carbon nanostructures, carbon fibers, fibrils, hollow carbon threads, solid carbon threads, fullerenes, graphenes, or mixtures thereof. In one aspect, the carbon nanostructures comprise a mixture of at least two types of carbon nanostructures. In another aspect, amorphous carbon materials can be formed in addition to other carbon nanostructures.

The size of carbon nanostructures produced using the methods herein can vary, and the present disclosure is not intended to limit the size or aspect ratio of carbon nanostructures that can be produced. In one exemplary aspect, the methods described herein can produce porous carbon threads having a diameter of from about 10 to about 200 nm in diameter. In another exemplary aspect, the methods described herein can produce multi-wall carbon nanotubes have a diameter of about 100 nm.

The yield of carbon nanostructures produced using the methods described herein can vary, depending upon, for example, the composition of unutilized carbon black feedstock and catalyst material employed in a given method. In one exemplary aspect, the yield of carbon nanostructures can be from about 100% to about 500%, from about 100% to about 400%, from about 100% to about 300%, or about 200% of the catalyst weight. In other aspect, the yield of carbon nanostructures can be from about 100 wt. % to about 750 wt. %, from about 100 wt. % to about 1,000 wt. %, from about 100 wt. % to about 1,250 wt. %, from about 100 wt. % to about 1,500 wt. %, from about 100 wt. % to about 2,000 wt. %, of the catalyst weight or more.

In one aspect, carbon nanostructures can be utilized as produced, without purification or removal of the catalyst. In another aspect, carbon nanostructures can be subjected to one or more purification steps to remove catalyst materials or other impurities. In various non-limiting aspects, such purification steps can comprise chemical treatment, for example, acid washing, or thermal treatment. Methods for purification of carbon nanostructures are known in the art and one of ordinary skill in the art could readily select an appropriate purification method, if desired.

In one aspect, carbon nanostructures produced by the methods described herein, prior to purification, can have a carbon content of from about 25 wt. % to about 80 wt. %, or greater than about 50 wt. %, greater than about 60 wt. %, greater than about 70 wt. %, greater than about 75 wt. %, greater than about 80 wt. %, greater than about 85 wt. %, or greater than about 90 wt. %. In another aspect, carbon nanostructures produced by the methods described herein, prior to purification, can comprise a hydrogen content of from about 0 wt. % to about 5 wt. %, from about 0.1 wt. % to about 3 wt. %, from about 0.1 wt. % to about 2 wt. %, from about 0.2 wt. % to about 1.5 wt. %, or from about 0.35 wt. % to about 1.5 wt. %.

In another aspect, carbon nanostructures produced by the methods described herein, after optional purification, can have a carbon content of from about 50 wt. % to about 99.9 wt. %, or greater than about 65 wt. %, greater than about 70 wt. %, greater than about 75 wt. %, greater than about 80 wt. %, greater than about 85 wt. %, greater than about 90 wt. %, greater than about 95 wt. %, greater than about 98 wt. %, or greater than about 99 wt. %. In another aspect, carbon nanostructures produced by the methods described herein, after purification, can comprise a hydrogen content of from about 0 wt. % to about 5 wt. %, from about 0.1 wt. % to about 3 wt. %, from about 0.1 wt. % to about 2 wt. %, from about 0.2 wt. % to about 1.5 wt. %, or from about 0.35 wt. % to about 1.5 wt. %.

In another aspect, the production of nanocarbon materials from the gaseous waste products from traditional carbon black production can enable more efficient use of the carbon black feedstock material, reduce environmental emissions, and/or produce a valuable product. In one aspect, the carbon nanostructure process can occur simultaneous, such as, for example, in an integrated manufacturing process, with the carbon black manufacturing process. In such an aspect, a continuous carbon black manufacturing process is positioned in connection with and upstream of a carbon nanostructure production process, such that the gases produced from the carbon black production process become the feedstock for the carbon nanostructure production process. In other aspects, the gases from the carbon black manufacturing process can be utilized as-is or can be subjected to one or more modification and/or purification steps to, for example, reduce non-desirable components, such as sulfur, and/or reduce the amount of water vapor present in the gas. In another aspect, unutilized carbon black feedstock can be stored for a period of time after the manufacture of carbon black, and then be used to manufacture carbon nanostructures as described herein. In still other aspects, the manufacture of carbon black and the manufacture of carbon nanostructures can occur at the same time. In other aspects, the manufacture of carbon black and the manufacture of carbon nanostructures can occur within a reasonable time period of each other, for example, if there is a delay in conveying the unutilized carbon black feedstock after the manufacture of carbon black.

In one aspect, the gas resulting from the carbon black manufacturing process (i.e., unutilized carbon black feedstock), either in its original unmodified form, or after treatment with one or more steps to remove, for example, sulfur and/or moisture, can be passed over a catalyst at a temperature of from about 500° C. to about 1,000° C., from about 500° C. to about 700° C., from about 600° C. to about 750° C., or from about 650° C. to about 700° C. for a period of time. In various aspects, the period of time can range from about 5 min to about 10 hours, from about 20 min to about 7 hours, from about 30 minutes to about 5 hours, from about 1 hour to about 10 hours, or from about 1 hour to about 5 hours. The specific temperature and time can vary depending on the particular catalyst, unutilized carbon feedstock, and desired carbon nanostructure material, and one of skill in the art could readily select appropriate time and temperatures values. In various aspects, the temperature and/or time can vary and can be less than or greater than any temperature or time period specifically recited herein, based, for example, upon the specific catalyst, gas composition, and/or desired carbon nanostructures. The flow rate of the unutilized carbon feedstock can vary depending on the configuration and other variable. In some aspects, the flow rate can range from about 0.05 to about 10 liters per minute, from about 0.05 to about 7.5 liters per minute, from about 0.3 to about 0.5 liters per minute, from about 0.1 to about 5 liters per minute, from about 0.05 to about 2.5 liters per minute, or from about 0.1 to about 1 liters per minute. In other aspects, the flow rate can be lower than or greater than any range or value recited herein, and one of ordinary skill in the art could readily select an appropriate flow rate. In another aspect, catalysts for the production of carbon nanostructures, such as nanofibers, nanotubes, nanosprings, and amorphous carbons are known, and one of skill in the art could readily select an appropriate catalyst and conditions for producing carbon nanostructures.

In another aspect, the produced carbon nanostructures can be collected, and the catalyst material can be optionally separated from the produced carbon nanostructures. Various techniques for separating carbon nanostructures and catalyst materials are known in the art.

The methods and compositions of the present disclosure can be represented in one or more of the following non-limiting aspects.

Aspect 1: A method for the simultaneous production of carbon black and carbon nanostructures, the method comprising: introducing a carbon black feedstock into a carbon black reactor to produce carbon black and unutilized carbon black feedstock, and contacting the unutilized carbon black feedstock with a catalyst at an elevated temperature in a carbon nanostructure reactor to produce carbon nanostructures.

Aspect 2: The method of aspect 1, wherein the carbon black reactor comprises a furnace carbon black reactor.

Aspect 3: The method of aspect 1, wherein the carbon black comprises an ASTM grade carbon black.

Aspect 4: The method of aspect 1, wherein the unutilized carbon black feedstock comprises, on a dry basis, from about 0 vol. % to about 1.5 vol. % methane, from about 0 vol. % to about 0.3 vol. % ethane, from about 0 vol. % to about 0.4 vol. % ethylene, from about 0 vol. % to about 75 vol. % nitrogen, from about o vol. % to about 30 vol. % hydrogen, and from about 0 vol. % to about 30 vol. % carbon monoxide.

Aspect 5: The method of aspect 1, wherein the unutilized carbon black feedstock comprises hydrogen and carbon monoxide in a ratio of from about 0.5:1 to about 15:1.

Aspect 6: The method of aspect 1, further comprising treating the unutilized carbon black feedstock to remove one or more impurities prior to being directed to the carbon nanostructure reactor.

Aspect 7: The method of aspect 6, wherein treating comprises removing moisture from the unutilized carbon black feedstock.

Aspect 8: The method of aspect 6, wherein treating comprises a contacting the unutilized carbon black feedstock with a dessicant and/or passing the unutilized carbon black feedstock through a condenser or cold trap.

Aspect 9: The method of aspect 6, wherein treating comprises removing sulfur from the unutilized carbon black feedstock.

Aspect 10: The method of aspect 6, wherein treating comprises contacting the unutilized carbon black feedstock with cadmium hydroxide.

Aspect 11: The method of aspect 1, wherein the unutilized carbon black feedstock comprises from about 10 ppm to about 5,000 ppm moisture.

Aspect 12: The method of aspect 1, wherein the unutilized carbon black feedstock comprises less than about 500 ppm sulfur.

Aspect 13: The method of aspect 1, wherein the catalyst comprises an iron-nickel catalyst.

Aspect 14: The method of aspect 1, wherein the catalyst and an internal portion of the carbon nanostructure reactor is heated to a temperature of from about 500° C. to about 1,000° C.

Aspect 15: The method of aspect 1, wherein the carbon nanostructure reactor comprises a tube furnace.

Aspect 16: The method of aspect 1, wherein the production of carbon nanostructures is continuous.

Aspect 17: The method of aspect 1, wherein the carbon nanostructures comprise single walled carbon nanotubes, multi-walled carbon nanotubes, carbon fibers, fibrils, hollow carbon threads, solid carbon threads, fullerenes, graphenes, or mixtures thereof.

Aspect 18: A carbon nanostructure prepared according to the method of aspect 1.

Aspect 19: The method of aspect 1, further comprising purifying a portion of the carbon nanostructures.

Aspect 20: A method for the production of carbon nanostructures, the method comprising: contacting unutilized carbon black feedstock obtained from the production of carbon black with a catalyst at elevated temperature to produce carbon nanostructures.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

### EXAMPLES

Various exemplary embodiments of the invention are detailed below. These embodiments are intended to be exemplary and are not intended to limit the scope of the invention. Unless indicated to the contrary, TEM images were obtained by dispersing the material of interest on holey carbon films.

### Example 1—Unutilized Carbon Black Feedstock

In a first example, unutilized carbon black feedstocks resulting from the production of carbon blacks were analyzed. Samples were collected from the production of various carbon black grades. Gas samples were collected from the carbon black manufacturing process using tedlar gas sampling bags. Gas composition was analyzed using a gas chromatograph, wherein organic components were separated using a molecular sieve column and detected using a flame ionization detector, and inorganic components were separated using an ethylvinylbenzene-divinylbeneze polymer column (Porapaq Q) and detected using a thermal conductivity detector. The moisture content of the gas samples were calculated using process parameters from the carbon black manufacturing process. The results of this analysis, on a dry basis, are detailed in Table 1, below.

TABLE 1
Gas Chromatograph Analysis of Unutilized
Carbon Black Feedstock

| | | | | | Carbon |
|---|---|---|---|---|---|
| Carbon | Methane | Ethylene | Nitrogen | Hydrogen | Monoxide |
| Black | (Volume | (Volume | (Volume | (Volume | (Volume |
| Grade | %) | %) | %) | %) | %) |
| BC-2109 | 0.44 | 0.147 | 61.09 | 13.54 | 15.53 |
| N-330 | 0.613 | nil | 57.71 | 17.99 | 17.56 |
| N-326 | 0.882 | 0.148 | 54.27 | 19.35 | 17.31 |
| N220 | 0.049 | 0.024 | 60.8 | 16.58 | 18.14 |

### Example 2—Production of Carbon Nanostructures

In a second example, carbon nanostructures were produced using unutilized carbon black feedstock and a catalyst material. The unutilized carbon black feedstock was taken from the carbon black manufacturing process via a tapping line at the carbon black dryer, treated, and conveyed to a tube furnace using a quartz tube. The treated unutilized carbon black feedstock gases were passed into and through the quartz tube, which was heated to a temperature of about 680° C. and which contained an unsupported iron-nickel catalyst disposed therein. The iron-nickel catalyst had a BET surface area of 5.363×10¹ m²/g, and a particle size distribution as follows: D₁₀—2.233 μm, D₅₀—8.765 μm, and D₉₀—23.955 μm. The elemental composition of the catalyst, as determined by inductively coupled plasma spectroscopy was 49% iron and 26% nickel. The treated unutilized carbon black feedstock was conveyed through the quartz tube at a rate of approximately 300 ml/min to 500 ml/min with a reaction time of from about 1 to about 5 hours. The sulfur content of the treated unutilized carbon black feedstock was reduced using a Cd(OH)₂ trap to a level of less than about 200 ppm. Similarly, the moisture content of the unutilized carbon black feedstock was controlled using parallel condensers with tap water circulation. The gas was also passed through a chiller maintained at a temperature of −3° C. to −5° C., and then through a silica trap prior to being introduced into the quartz tube. The moisture level was reduced to a level of from about 100 to about 1,000 ppm. Moisture content was measured by passing the treated gas stream through a weighed amount of methanol for a fixed period of time, and then analyzing the methanol using a Karl Fischer moisture analyzer. Samples were collected at two points: (i) after the parallel condensers, and (b) after the silica gel trip.

Carbon nanostructures produced would flow, together with the gas flow and gravity, to the discharge outlet located at an opposing end of the tube from the inlet. The ports of the quartz tube (e.g., inlet, outlet) were sealed to prevent the escape of produced carbon nanostructures and the intrusion of air. The carbon nanostructures produced were collected in a vessel for subsequent analysis.

The production of carbon nanostructures was carried out using treated unutilized carbon black feedstock from the manufacture of a number of carbon black grades. After completion of each reaction, the produced carbon nanostructures were collected and analyzed. The percent carbon was determined using a CHNS analyzer, and the total carbon yield calculated. This data was also compared to experiments where pure gases were utilized instead of treated unutilized carbon black feedstock.

### Example 3—Analysis of Carbon Nanostructures Produced Using Unutilized Carbon Black Feedstock

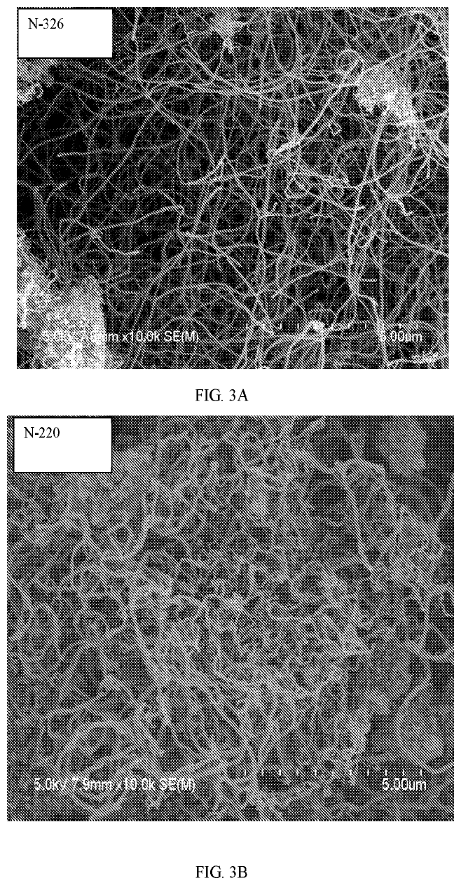

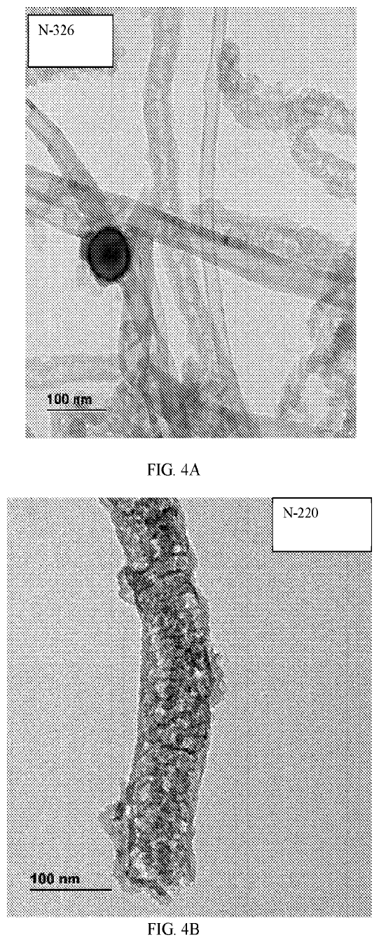

In a third example, samples of carbon nanostructures produced using unutilized carbon black feedstock were analyzed via scanning electron microscopy (SEM) and transmission electron microscopy (TEM). FIGS. 3A and 3B illustrate SEM micrographs of carbon nanostructures prepared using unutilized carbon black feedstock from the manufacture of N326 and N220 grade carbon blacks. These micrographs illustrate the formation of filamentous carbon nanomaterials. FIGS. 4A and 4B illustrate TEM images from samples of carbon nanostructures prepared from unutilized carbon black feedstock from the manufacture of N326 and N220 grade carbon blacks. These TEM images reveal the formation of a mixed morphology of carbon threads, carbon fibers, and carbon nanotubes.

Samples of carbon nanostructures prepared from unutilized carbon black feedstock from various carbon black grades were also subjected to elemental analysis via a CHNS analyzer, as detailed below in Table 2.

TABLE 2
Elemental Analysis of Carbon Nanostructures

| Carbon Black | | | |
|---|---|---|---|
| Grade | C | H | S |
| BC-2109 | 68.555 | 0.700 | 2.640 |
| N-330 | 75.188 | 1.313 | 1.952 |
| N-326 | 81.069 | 0.355 | 0.272 |
| N-220 | 68.292 | 1.457 | 1.366 |

The carbon nanostructure samples were also subjected to Raman spectroscopy, the results of which are detailed in Table 3, below.

TABLE 3
Raman Analysis of Carbon Nanostructures

| Carbon Black | ~1340 (D) | ~1596 (G) | |
|---|---|---|---|
| Grade | cm⁻¹ | cm⁻¹ | I_{D}/I_{G} |
| BC-2109 | 179 | 186 | 0.96 |
| N-330 | 1127 | 1596 | 0.70 |
| N-326 | 1347 | 1579 | 1.08 |
| N-220 | 580 | 651 | 0.89 |

What is claimed is:

1. A method for the simultaneous production of carbon black and carbon nanostructures, the method comprising:
a. introducing a carbon black feedstock into a carbon black reactor to produce carbon black and unutilized carbon black feedstock, and
b. contacting the unutilized carbon black feedstock with a catalyst at an elevated temperature in a carbon nanostructure reactor to produce carbon nanostructures.

2. The method of claim 1, wherein the carbon black reactor comprises a furnace carbon black reactor.

3. The method of claim 1, wherein the carbon black comprises an ASTM grade carbon black.

4. The method of claim 1, wherein the unutilized carbon black feedstock comprises, on a dry basis, from about 0 vol. % to about 1.5 vol. % methane, from about 0 vol. % to about 0.3 vol. % ethane, from about 0 vol. % to about 0.4 vol. % ethylene, from about 0 vol. % to about 75 vol. % nitrogen, from about o vol. % to about 30 vol. % hydrogen, and from about 0 vol. % to about 30 vol. % carbon monoxide.

5. The method of claim 1, wherein the unutilized carbon black feedstock comprises hydrogen and carbon monoxide in a ratio of from about 0.5:1 to about 15:1.

6. The method of claim 1, further comprising treating the unutilized carbon black feedstock to remove one or more impurities prior to being directed to the carbon nanostructure reactor.

7. The method of claim 6, wherein treating comprises removing moisture from the unutilized carbon black feedstock.

8. The method of claim 6, wherein treating comprises a contacting the unutilized carbon black feedstock with a dessicant and/or passing the unutilized carbon black feedstock through a condenser or cold trap.

9. The method of claim 6, wherein treating comprises removing sulfur from the unutilized carbon black feedstock.

10. The method of claim 6, wherein treating comprises contacting the unutilized carbon black feedstock with cadmium hydroxide.

11. The method of claim 1, wherein the unutilized carbon black feedstock comprises from about 10 ppm to about 5,000 ppm moisture.

12. The method of claim 1, wherein the unutilized carbon black feedstock comprises less than about 500 ppm sulfur.

13. The method of claim 1, wherein the catalyst comprises an iron-nickel catalyst.

14. The method of claim 1, wherein the catalyst and an internal portion of the carbon nanostructure reactor is heated to a temperature of from about 500° C. to about 1,000° C.

15. The method of claim 1, wherein the carbon nanostructure reactor comprises a tube furnace.

16. The method of claim 1, wherein the production of carbon nanostructures is continuous.

17. The method of claim 1, wherein the carbon nanostructures comprise single walled carbon nanotubes, multi-walled carbon nanotubes, carbon fibers, fibrils, hollow carbon threads, solid carbon threads, fullerenes, graphenes, or mixtures thereof.

18. A carbon nanostructure prepared according to the method of claim 1.

19. The method of claim 1, further comprising purifying a portion of the carbon nanostructures.

20. A method for the production of carbon nanostructures, the method comprising contacting unutilized carbon black feedstock obtained from the production of carbon black with a catalyst at elevated temperature to produce carbon nanostructures.
